(19) United States
(12) Patent Application Publication
(10) Pub. No.: US 2002/0123359 A1
(43) Pub. Date: Sep. 5, 2002

(54) Network for information transfer for mobile stations

(75) Inventors: Winston Ser Tuen Wei, Singapore (SG); Eugene Ghe, Singapore (SG)

Correspondence Address: GREER, BURNS & CRAIN, 300 S WACKER DR, 25TH FLOOR, CHICAGO, IL, 60606, US

(73) Assignee: Multiscience System Pte Limited

(21) Appl. No.: 09/998,695

(22) Filed: Nov. 30, 2001

Related U.S. Application Data
(63) Continuation-in-part of application No. 09/803,861, filed on Mar. 12, 2001.
(60) Provisional application No. 60/250,673, filed on Dec. 1, 2000.

(51) Int. Cl. H04Q 7/20

(52) U.S. Cl. 455/466; 455/414

(57) ABSTRACT

Search templates for a web portal search engine of the internet are provided and a method of use of such templates in customer transactions is provided. The method incorporates processing coded information in respect of a transaction by a customer and a merchant, the customer being a user of a mobile phone with a search template, which phone is connectable to an SMS server, which in turn is connectable to the Internet; the merchant having a GSM device connectable to a GSM terminal and to the Internet; each customer having a unique identification number (“UIN”) for use in transactions; each merchant having a unique identification number for use in transactions; wherein the customer and merchant can complete a secure transaction.

This application is a continuation in part of, and claims benefit of the filing date of, and hereby incorporates fully be reference, the pending parent application entitled Network for Information Transfer for Mobile Stations initially filed as Ser. No. 60/250,673 filed Dec. 1^{st}, 2000 and continued in Ser. No. 09/803,861 filed Mar. 12^{th}2001.

### DESCRIPTION OF USE

The present invention generally relates to a method and system for sending and retrieving information from the internet over a mobile network to a mobile phone. Generally the method and system can be used for both secure and non secure sending/receiving and permits the channelling of consolidated data to a webserver on the internet.

### BACKGROUND OF INVENTION

After the proliferation of Internet eCommerce, another wave of communication has also arisen, called “mCommerce” (mobile commerce). This form of communication is very similar to surfing the Internet for eCommerce, but instead of a personal computer and modem a WAP phone, connected to the telecommunications provider's WAP-enabled gateway for a connection to access websites, is used. These phones and WAP gateways use WML (Wireless Markup Language). This requires customers to login to their respective telephone networks and customers are charged based on the hours of connectivity. Furthermore, there is a monthly subscription fee.

The Short Message Service (SMS) is the ability to send and receive text messages to and from mobile telephones. The text can comprise words or numbers or an alphanumeric combination. SMS was created when it was incorporated into the Global System for Mobiles (GSM) digital mobile phone standard.

A single short message can be up to 160 characters of text in length using default GSM alphabet coding and 140 characters when USS2 international character coding is used.

GSM is an international standard for digital mobile telephones. In Europe and Asia, a mobile telephone can be modified to work in any country in the region. GSM requires a transmitter every five kilometres, so it is not entirely suitable for low-population areas like America and Africa. SMS messages can be transmitted and/or received on a GSM telephone display. Normally SMS can be used to let the mobile user interact with the internet for a number of activities, for example email, news headlines, traffic reports etc. GSM also provides a digital data line at 9600bps which can be connected to compatible equipment without the need for a modem.

From the point of view of the user of a mobile phone for a connection to the internet it is apparent from this system that for uplinks and downloads from the internet to a mobile phone or a mobile receiver, it is necessary to use the gateway of the telecommunication provider. However telecommunication providers and users of the internet do not always use compatible protocols, creating problems for transactions and information transfer when a mobile user wants to download or upload from sites on the internet.

From the point of view of retailers using the internet there is an extremely limited amount of information that can be downloaded from the internet to a mobile user through the telecommunication service provider. The same problems of protocol compatibility also exist. Some aspects of these two concurrent problems have been addressed to date.

For example, in U.S. Pat. No. 5,946,629 (Sawyer) a message communications system for internet intra-network messages is disclosed. The message center for the cellular network includes functionality for processing received messages and forwarding these to other connected networks. The protocol of the messages is established so that a destination identifier is used, permitting speedy forwarding of the message to the desired destination of the sender. The center functionality permits communications to be speeded up between cellular networks (using SMS messaging format), conventional telephone networks and Wide or Local Area Networks (in email format).

However, much of the work done in the message center needs manual interaction or supervision and also requires the message center to be part of a cellular network, thus being intimately connected with the telecommunication service provider.

U.S. Pat. No.5,159,592 (Perkins) provides apparatus and a method for managing transmissions in both directions between a wired network and at least one mobile communication unit. The unit is in wireless communication with the wired network. Each user is assigned a unique network address (for example, TCP/IP protocol address). A local gateway is coupled with a wireless Local Area Network and the wired network for communication with the mobile unit.

While this may remove the problem for the mobile user of requiring use of the telecommunications server gateway, it does not address the problem of the ability of the mobile user to actively interact with the internet in a format that is both readable and interactive at the user end.

U.S. Pat. No. 5,353,331 (Emery) addresses some of these problems, but with reference to each mobile subscriber's home location register. U.S. Pat. No. 5,603,081 provides a system for sending paging messages and packets of information to and from a remote station, but not interactive communication.

U.S. Pat. No. 5,915,222 (Olsson) relates to a SMS communications network but does not address the question of interaction from the mobile with the internet.

Various other disclosures have been made regarding aspects of the interconnection between mobile phones and the internet or between a wireless network and the internet. Examples of these can be seen in U.S. Pat. No. 5,661,516 and U.S. Pat. No. 6,097,961.

More recently specific problems with interfacing between mobile phone users and the internet have been addressed. For example, U.S. Pat. No. 6,125,281 (Wells) addresses the problem of a mobile user wishing to interface with a PC through the internet, where the PC may be switched off or disconnected from the internet part way through the activity. A method is disclosed for operating the mobile station with bi-directional communication with a base station and a mobile switching center. A database is provided within the switching center that is bi-directionally coupled to the mobile center and to the internet or other functions. The information is stored in the database if it cannot be sent immediately and sent as soon as the end user is back online/free.

However this does not address the difficulty that the mobile phone does still not provide an interactive system between the mobile phone and the internet.

U.S. Pat. No. 6,078,820 (Wells) addresses some aspects of the problem within the interactivity between a mobile telecommunication system and other systems, principally the internet, by addressing the format of SMS messages. The patent discloses a method of electronically determining if the SMS message has a first or a second transfer format. If the message has a first transfer format the message is processed in a conventional manner. If the SMS message has the second transfer format the message is passed to locate an application identifier entry. If the mobile station supports that application identifier entry then the message is forwarded unchanged. If the application identifier is not supported by the mobile phone the data entry of the SMS message is processed and displayed with a first display format.

If the application identified is present the data is displayed with the second display format specified by the application.

Thus while this method permits determining whether or not the message can be translated into a readable form for one particular cell phone, does not necessarily provide a universal method without the requirement for further translation into or from other systems' protocols.

In WO 0072612 an aspect of the above problem is addressed. The invention disclosed is to a system and method for providing information to a mobile phone in response to a request for such service from a communication device. The user of the mobile phone can dial a service requesting information be forwarded to it. This can be initiated either by inputting digits on the mobile station, or by the use of a micro-browser in the mobile. The input triggers an SMS message, which is sent to a wireless web information service gateway. The gateway acts as a service provider/manager and retrieves the requested information from one or more sources. This information is forwarded via a SMS message or a micro-browser and stored according to a pre-selected format within the mobile station.

However, the wireless web information service gateway requires that the information requested be in accordance with a predetermined profile for that user and for a particular profile of information requested. This has to be pre-programmed for the gateway in order to be useable. Further, it requires the programming of the mobile station or the requirement that the mobile station have a micro-browser. Some mobile stations are not pre-programmable in this manner and do not have an associated micro-browser. Thus, for such mobile stations the application could not be used.

A proposed telecommunication system, the Universal Mobile Telecommunication System (“UMTS”), is a proposed system for addressing problems in this field. It is proposed that such a system will enable the delivery of high-value broadband information to mobile users via wireless or satellite networks. Such systems are now in field trials. It is proposed that it will enable delivery of pictures, graphics, video communication and other wide-band information. UMTS will also assist in the delivery of voice and data information to mobile stations. However, the system is experimental, will require additional hardware and software for use with a mobile station, and is not operable without this.

Currently, tangible or paper vouchers are one form of non-cash payment, but is only accepted in the company where it is purchased from, and the same voucher cannot be used in multiple companies or trades. However, with the existence of the wireless invention, a person can purchase e-vouchers of any amount from a finance company, and they can be used in all companies of any trade that have already been registered with the finance company.

Such e-vouchers can also be made obtainable with every specified amount deposited or renewed in a finance company. For example, instead of earning interest, an e-voucher of $50 is receivable with every $2000 deposited in a finance company. These e-vouchers can be used in any retail, or service, company registered with the finance company.

It is therefore an object of this invention to provide protocols and engines for interactive use of a mobile station and the internet, which do not necessarily require WAP protocols, but which can be used in conjunction with SMS.

It is a further object of this invention to provide such an interactive system that implements the use of a mobile station for such activity, irrespective of location.

It is a further object of this invention to provide a system and method for mobile inter-communication/activity between a wireless network and the internet. It is a further object of this invention to provide a system and method for wireless communication and interactive use of the internet irrespective of the telecommunication service provider.

### SUMMARY OF INVENTION

The foregoing and other problems are overcome and the objects of the invention are realised by methods in accordance with embodiments of this invention.

The present invention also provides search templates usable on a mobile phone, each said template being capable of use by a mobile user, each said template being in the form of a search index card capable of use to compose an alphanumeric message for broadcast by the user via mobile phone to a server gateway, there being no need for the mobile user to have an internet address.

Optionally, each template can be printed, where a mobile user is connected to a printer. Also, the templates can be printed from the internet at a fixed station and then used by a mobile user when mobile.

The present invention further provides a method of processing coded information in respect of a transaction by a customer and a merchant, the customer being a user of a mobile phone with a search template, which phone is connectable to an SMS server, which in turn is connectable to the Internet; the merchant having a GSM device connectable to a GSM terminal and to the Internet; each customer having a unique identification number (“UIN”) for use in transactions; each merchant having a unique identification number for use in transactions; wherein the method comprises the steps of

the customer uses the search template to send the merchant UIN and the customer security number to the SMS server;

the SMS server confirms the validity of the merchant UIN to the customer by sending a secure acknowledgement in the form of an SMS signal readable on a mobile phone using the search template, and displayable to the merchant;

the merchant forwards the secure acknowledgement SMS to the SMS server;

the SMS server effects the completion of the transaction by directing an entry to specified records indicating the consideration offered the customer for the transaction;

the SMS server sends a secure acknowledgement to the merchant and the customer, said acknowledgement being an SMS signal capable of being read through a search template on the mobile phone and by the GSM device, wherein

said template is in the form of a search index capable of carrying pre-determined information and coding instruction and being both capable of use for composing an alphanumeric message for broadcast, and capable of use for interpreting a received message, by the user, said message being transmitted through a mobile phone network and the SMS server.

Optionally, the search messages are sent on the GSM network to the mobile operator's SMS gateway, thence to an SMS server for on-forwarding to the Internet. The protocols between the SMS gateway and SMS server, and the SMS server and the Internet, are all the same, and optionally, TCP/IP protocols are used.

Optionally, the SMS server is also the web server for the web portal. Such a web server is equipped with SQL database to hold the information relating to the portal and the mobile users. There is thus no requirement that HTML coding be known to the mobile user.

For the above example of an ordering search index, the SMS template can be filled out, and sent by mobile via the SMS gateway to the SMS server. The SMS server then uses an internet connection of known type to facilitate the order search over the Internet.

Once results are forwarded to the mobile user from the SMS gateway, the mobile user can use the templates for further queries within the results or to move onto another search.

One or more e-Commerce sites on the internet can also use the SMS server for downloading information and requests to a mobile user. For example, a company may establish a search template for questions it requires answers to, which template can be downloaded via the SMS server and SMS gateway to one or a number of mobile users.

Additionally, the SMS server can be used to process material to some extent before downloading to the mobile user. Additionally, the template can be used to encode a particular level of security, desired by the mobile user. The SMS message can encode the information with that level of security, regardless of where the message is on-forwarded to.

The present invention also provides a method of processing coded information in respect of a transaction by a customer and a merchant as described above wherein the SMS server is connectable to one or more clearing houses which are selected from: a security clearing house, one or more banks; a credit transfer facility; wherein the specified records in respect of which an entry is to be made to effect the completion of the transfer are contained at least one of said clearing houses.

The present invention further provides a method of processing coded information in respect of a transaction by a customer and a merchant as described above wherein the records altered to complete the transaction are selected from: e-coupon records of the customer and e-coupon records of the merchant; a credit card of the customer, and account of the merchant; a bank account of the customer and of the merchant; redemption of tickets from a competition; entries in the records of a bonus point loyalty scheme; and a combination of these.

The present invention also provides a method of processing coded information in respect of a transaction by a customer and a merchant as described above wherein said GSM device is further connectable to a data storage medium, display device and programmable means of the merchant, said data storage device and programmable means being programmed to receive information on each transaction of the merchant, and whereby the programmable means is operable to display selections of information on the display device; which are selected from: number, type and value of total sales in a given period of time; number, type and value of specified types of sales in a given period of time; number, type and value of bonus points generated and redeemed in a given period of time; number, type and value of coupons dispensed and redeemed in a given period of time; and a combination of these.

The advantage of this system is that there is one protocol with SMS for a mobile user to interact with any merchant, regardless of the type of consideration being used to complete the transaction.

### BRIEF DESCRIPTION OF DRAWINGS

Further aspects of the present invention will become apparent from the following description which is given by way of example only and with reference to the accompanying drawings in which:

FIG. 1 is a diagrammatic representation of the system of the present invention; and

FIG. 2 is a diagrammatic representation of an example of the method of the present invention;

FIG. 3 is a flow chart of another example of the method of the present invention;

FIG. 4 is a flow chart of dissemination of SMSs to multiple recipients;

FIG. 5 is a flow chart of consolidation of responses from multiple recipients;

FIG. 6 is a flow chart of SMS consolidation and dissemination according to the present invention;

FIG. 7 is a sample web page according to a preferred embodiment of the present invention; and

FIG. 8 is a flow chart assigning tasks according to the present invention.

### DETAILED DESCRIPTION

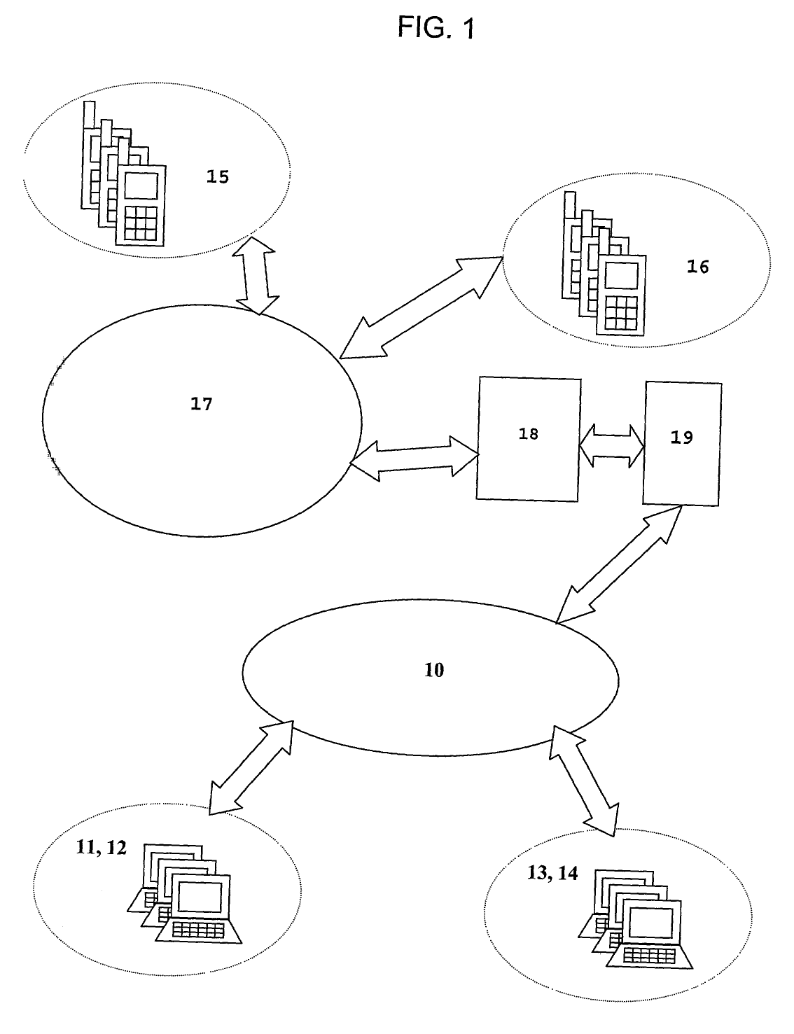

Referring now to FIG. 1, there is shown a diagrammatic representation of a series of networks for implementing the system of the present invention. The internet is generally represented by the numeral 10. The internet (10) includes connections to corporate users and customers in a first country (11, 12 respectively, and country A), and corporate users and customers in a second country (13, 14 respectively and country B) all being of known type. All users (11-14) are generally denoted by use of a fixed computer system and modem for inter-connection to the internet (10) and may themselves be on a LAN and/or a WAN.

Mobile users in two countries (respectively 15, 16 in countries B and C) may be using mobile stations for any or all of the functions of:

placing purchase orders through the internet (10);

downloading information to a site on the internet (10); and/or

uploading information to a site on the internet (10).

The station is generally a digital mobile phone of known type.

Such end sites (including sites 11-14) can be in any country (A, B or C). The mobile user (15, 16) is connected to a GSM network (17), and uses SMS on that network (17) to connect with the mobile operator's SMS gateway (18). Connection between the SMS gateway and the SMS server (19) is in the frame of TCP/IP protocols. The SMS server (19) is connected to the internet (10) within a framework of TCP/IP protocols.

Each SMS server (19) generates one or more templates which can be printed out by the mobile user (15, 16) or used without the need for printing, as is desired. The instructions on the template are used to compose a search message. The search message is sent via SMS to the SMS gateway (18), onto the SMS server (19) (etc) in known manner. The SMS server (19) returns the results of the search in a single SMS message. The mobile user (15, 16) can then uses the SMS format to query the SMS server (19) for more results or subsequent searches.

The template can also include instructions which can be coded for the SMS server (19) as to how the message or the content of the template is to be on-forwarded. For example, a simple numeric coding can be used to direct to the SMS server (19) to on-forward the SMS via email, SMS or a video link, etc. The SMS message can be coded for security, as is desired. The coding can include encryption, of known type, and can be added to the message for use regardless of where the message or information from the message is on-forwarded to. Similarly templates for downloading information to the mobile users (15, 16) can incorporate security.

While the example given is the use of a template to format searches for the SMS server (19) to process, it will be appreciated that the template may be differently structured so that the mobile user (15, 16) can, for example, order services or goods over the internet (10), request a personal follow-up, etc.

Similarly, it will be appreciated by those skilled in the art that the users (11-14) of the internet may also structure a template for downloading information or requests for information via the SMS server (19) to the end user (15, 16). Such template could form part of a survey; could include advertising, and so on. The end users (15, 16) can either complete the template and return an SMS message, or act on the information received via the template, as is desired.

The above described system will be further described with reference to the following examples.

### EXAMPLE 1

A sports club has members and obviously wishes to look for new members. Existing members or new members, after registration, (can through the method of the invention) receive updates via mobile phones on such matters as: broadcast email, amendments to game schedules, up to date changes for games and team, club specials and special offers available to club members only. The sports club, on the other hand, can view consolidated data from the website such as the club members' names and age. The organizers of the SMS campaigns can SMS in to query the latest consolidated results/responses.

The club might otherwise use traditional means such as club notice boards, or broadcast media (newspaper, television, etc) to advise club members of these special offers or these updates. Once club members are advised, any offer or update can either be reviewed and returned via coupons in printed media, or members can request and obtain coupons via the internet or SMS through the method of the present invention.

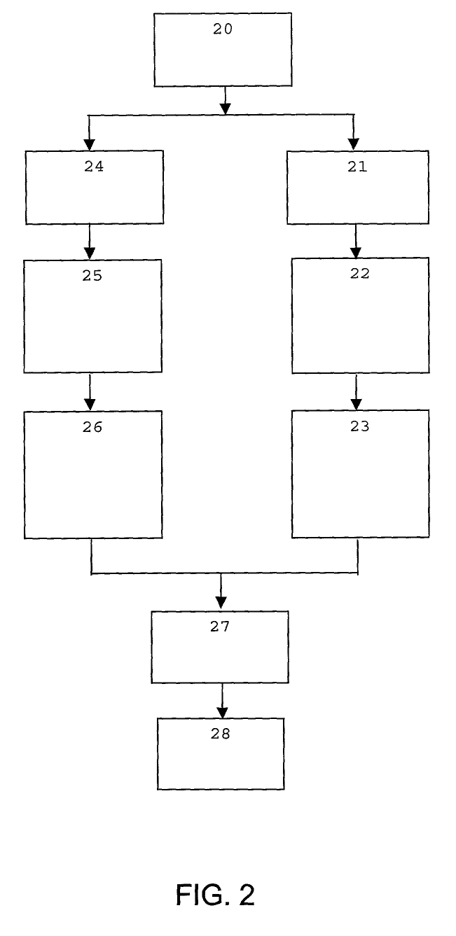

Referring to FIG. 2, when members (20) redeem the e-coupons via SMS these can be redeemed through the mobile system (21-23) and confirmed through a simple procedure within the club administration. The club's online e-marketing (24) confirms the password of the day, through email and SMS (25) that the e-coupons can be redeemed as the correct message of the day password has been used by the member (20) by the member's ID or name (26). The member (20) can through SMS and the method of the present invention make payment (27) and arrange pickup for delivery (28). Tracking of each redemption, the outlet used and time of redemption can also be formulated into a report for ease of administration.

The example given above is a sporting club, which also uses the SMS system for selling goods or services to its members, in addition to other information. However, it will be appreciated that any organisation may use this structure. It need not be a club. The members (20) could be customers of a company or a retailer. The items on offer could represent goods or services.

In a further variation, a second GSM device at the redemption outlet can be used for authenticating the redeemed e-coupon. This GSM device verifies the handphone number of the user (15, 16) with the SMS server (19). The GSM device is selected from: cellular phone, POS (Point Of Sales) system, cellular phone with chatboard, cellular phone with keyboard. The latter two options aid in the inputting of text of data and have a lower cost of operation than POS systems.

The use of an e-coupon is advantageous as a bonus/reward for registration (the method of which is discussed below), or other operation or electronic activity with customers. An e-coupon can be easily collected/stored by the user (15, 16) after user participation in an SMS or internet (10) based activity. Examples of such activities include: on-line activities such as participating in a quiz, a survey, a contest or a puzzle. On triggering a hyperlink of an advertisement (which may include a banner advertisement on the internet (10)) the user (15, 16) provides the address number of the mobile device used by the user (15, 16), to which the advertiser transmit an e-coupon. This can be redeemed in the manner described above.

### EXAMPLE 2

The second example is that of using the method and system of the invention for hunting for an apartment/accommodation. Once registration has occurred with a service or company and that company has the customer details, online forms can be collected for a single information request by the SMS system of the invention. A template of the type in accordance with the present system can be used to submit the criteria for the property looked for. Tables 1 and 2 set out examples of such templates and the resultant coded message that can be sent the SMS, so that the information regarding available accommodation that fulfills the requirements can be downloaded to a mobile station. As for the company, a consolidation of data such as the names and age of the customers can be retrieved from the website. Moreover, the organizers of the SMS campaigns can SMS in to query the latest consolidated results/responses.

The template is filled out (either mentally or manually) and coded as set out in Table 1, Table 2. Table 3 sets out the reply, which can then be decoded using the material on the template. For example, as shown in the Tables, the mobile user is looking to see what is available as a three-bedroom flat or apartment located in a specified “area”. The message set out in Table 2 is composed and Table 3 shows the specific listings that come back, which can be interpreted with the use of the template from Table 1. Thus listings can be made with much less detail and can be downloaded through a mobile network while the mobile user out looking at property. The internet based company (13, FIG. 1) through the SMS server (19) can also track who the inquirer is and be able to follow up directly on the request in an efficient manner.

Security can be added to all such examples in known manner. The mobile user (referring to FIG. 1, 15) registers with the SMS server (19) to obtain a security code or key, which is transmitted either to the mobile station (15) or via email. This can be used to authenticate the rightful owner of the mobile station (15) using the services. Alternatively, a two layer security system may be used. The security code is used to validate a user (15, 16). The SMS data includes information to validate the originating address (cellular phone number).

### EXAMPLE 3

The third example is that of building a user database by means of the present invention. Such a database could for example be one that is used in Example One for the sports club. Once the user database is established it can be used in the manner described above to broadcast target messages (for example marketing and or updates) to members on the database.

Similarly the invention can be used to acquire more information on a customer or client for the database of users. The following example of registration is a particular instance of this example.

REGISTRATION

Company names 2-20 characters follow by # key

4-8 character for user name follow by # key

Email address follow by # key respond

Age follow by # key

Gender follow by # key

IC number follow by # key

DELI#JEREMYLING#JEREMY@YAHOO.COM#30#M#A3388667#

Thank you XXXXX, welcome to iSMS, we already receive your registration, looking forward for your reply.

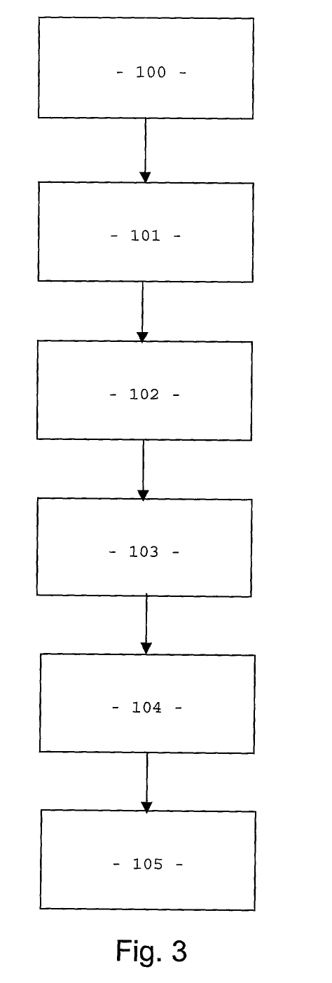

This system is as set out in the flow chart as shown in FIG. 3. The end user registration process (100) starts with a registration (101) as described above. The SMS server responds with an automatic reply (102) requesting a password via SMS. The SMS server optionally, also automatically generates a security code or password for more secure services or transactions by the user. An email (103) and detail for registration is forwarded. This details is entered on the webpage (104) and allows the user to start using the services (105) once the details on the webpage are completed. After this step further communication can be through one or more of a multiple of channels (SMS, mobile, email, fax, etc).

### EXAMPLE 4

A fourth example is the use of the above-described invention for online payment authentication. Frequently a credit card is authenticated online via the use of the card members name, number and card validity date. An ATM card is authenticated by the use of a password.

The above system can be used to validate each of these modes of payments without the need to key in a card number for either system. A password is keyed in as described above and the payments are consolidated to a single monthly account to the user.

For example a buyer orders 1 Compaq's iPaq PDA from eComStore.com costing US$500.00. When the buyer checkout the order, he/she is asked to register with eComStore.com before any checkout can be done.

After that, she is asked to choose the payment mode as follows:-

1. Cash on Delivery

2. Credit Card

3. SMS Payment (via Handphone)—Monthly single bill collection

Using the method of the present invention, the validation process (payment) is as follows:-

1. The order info as follows is send via SMS on to the buyer's mobile phone:

Transaction 125D3

eComStore's

Compaq-iPAQ

Price US$500.00

Confirm by forwarding the MSG with YES to 655655

2. The SMS server generates the below message to the buyer.

Transaction 125D3#KeyKJHG 12637489KKS88882222DDD2221#keyinPassword#

Please note: Key “KJHG12637489KKS88882222DDD2221“is a 30 alphanumeric code generated from the Server Engine which encode the Transaction ID, Date, Time, Handphone No. and Server Side key to form the above key.

3. The buyer forwards the above message to 655655 and delete the text “keyinPassword#”and replace it with his/her Password eg. “PW12345#”.

Transaction 125D3#KeyKJHG12637489KKS88882222DDD2221#PW12345#

4. Once the SMS Gateway receives the message, it proofs that the message has been received from the Buyer and the iPayment's Server will decrypt the key and Match the mobile phone No. within the key with the Message's Originating Address(mobile phone number.). It will go through a series of decryption and validation processes before the Payment can be authenticated. Finally, an “ACCEPTED and Delivery Message” is sent to the buyer.

### EXAMPLE 5

A fifth example is the use of the above described invention for the m-Commerce arena. Presently for non-cash payments the parties involved in the transaction include: the customer, the merchant and clearing house. The clearing house can be a financial institution, bank, or the use of a Visa, MasterCard, (etc) credit card, often with bill collection being through a respective telecom provider. It can consolidate and eliminate the issuing of printed vouchers, which allow redemption off the purchased amount during a transaction, by introducing a top-up e-voucher account. This will serve as the float or prepaid amount account for the any m-Commerce transactions.

Commencement of the system is via provision to the merchant of one or more GSM terminals. The method of the present invention eliminates any necessity of incorporating extra programming to existing POS systems. Furthermore, most of the current non-cash transactions as described above are merchant initiated and that causes the possible frauds.

With the present invention, it is customer-initiate oriented. The customer has to inform the commerce server which merchant he/she is making the payment to and the commerce server will authorize this transaction by their pin number. Therefore even if merchants try to initiate a transaction, it is not, thus making it a much safer than current non-cash payment process.

Each merchant is assigned an SMS ID number useable for both transaction registration and transaction validation. An example of such a number is:

* 1111 (registration) and *11110 (validation).

Each customer is issued with an SMS commerce PIN identification number, which can be four to six digits, as is the case with a ATM card PIN. An example of this is PIN 2222.

For example, if a customer user (15, 16) wishes to purchase groceries to the value of $59.00 from the merchant (ID number * 1111), that person can choose to pay by SMS in accordance with the method of the above invention, as follows:

The customer (15,16) sends an SMS using the merchant ID number and their PIN commerce authorisation number via a mobile phone. The customer (15, 16) receives an acknowledgment or security number (1234) from the commerce server, via SMS signal. The customer displays the security number to a cashier at the merchant. The cashier SMSs the merchant ID and acknowledgment security number to the SMS server (19). The server (19) processes the completed transaction, with both the merchant and the customer (15, 16) receiving a confirmation note, and receipt of purchase via SMS to respectively the mobile phone used by the end user (15, 16) and the GSM terminal of the merchant. In addition, any data submitted via handphone from customer (15, 16) to merchant or vice versa, such as the name/age of the customer (15, 16) and the purchased items/dates/quantity, can be consolidated and accessed via the Internet. The merchant can generate various reports from the consolidated data. For example, the merchant can generate a report on the number of cans of x brand drinks purchased in February, or a report on the number of customers in June and December.

The customer (15, 16 ), on the other hand, can log on to the website to check past purchase records, and can select directly from past records the items that he/she wishes to purchase online. The present invention also enables customers (15, 16) to pre-define a shopping cart in the web first (in known manner) and later trigger the ordering via sending a SMS message.

According to the Internet Home concept, the virtual inventory system allows the customer (15, 16) to keep track of the supply of products at home. The wireless invention will be able to coordinate with this system such that if there is a shortage of any supply at home, a SMS message will be sent to the user (15, 16), asking whether the user (15, 16) would want to add into the virtual cart the item that is :deficient. If the user (15, 16) wants to the reply can be sent via SMS and the system will automatically include the item into the cart. If the user (15, 16) wishes to preview the shopping cart, the user (15, 16) can do so by sending a SMS message.

In a further variation of this example, unstructured supplementary services data (USSD) systems may also be used. Such a system is a GSM service allowing high speed interactive communication between subscribers and applications on a GSM network. Typically, the end user (15, 16) requests services by entering a specific short sequence of characters at the mobile phone (for example, *101#). The sequence is passed across the mobile network to the USSD server and routed to the application in question. The application center responds back to the subscriber through the USSD server within the same signaling session. Thus there is minimal delay between the sending of a query and receiving the response other than the application processing time.

An additional feature of this and Example Four is that the end user (15, 16) can use SMS to request a monthly bill of the commerce service provider.

Additional security, in manner described above, can be provided to customers of this style of service with the provision of specific numbers through the mobile phone to activate and deactivate the commerce facility. In like manner, accounts receivable, or monthly spending limits can be set.

In addition to the above, supermarkets have traditionally accepted cash or credit payments from customers without receiving much useful information on who their individual customers are and what they have each purchased. Tapping on the invention of SMS payment as described in this Example, supermarkets' patrons are now able to make secured wireless payments. Simultaneously, supermarkets can receive a consolidated record of the items purchased by each customer.

Such consolidated record allows the marketing and sales personnel to trace each customer's buying behaviour/pattern. Thus, they can identify each customer's frequently-purchased products, and then target each customer with only those promotions that he will likely be interested in. Other marketing strategies, such as e-Coupon distribution and contest participations via SMS, can also be developed from the analysis of such consolidated data.

The data consolidated are accessible via the website allowing various reports to be generated automatically. Examples of reports include the report on the number of customers from January to March and the report on the age group of customers who had purchased a certain product. The data collated also enables stock forecast and inventory checks to be established instantly.

The items paid via SMS will automatically be recorded in the respective customer's website, enabling him to view his past purchase records online. He can even make online purchase by using the mouse to select items from his past purchase list. This makes purchase online more efficient since he does not need to search for the desired product from the supermarket's catalogue.

Such invention is not limited to any retail or service industries where payment, purchase or contest need to be carried out.

### EXAMPLE 6

The sixth example in the use of the above described invention is a modification for issue of tickets for a lucky dip, for use as a customer loyalty bonus, or as an incentive to purchase (etc). Traditionally, customers at a store who are offered a lucky dip after purchasing a certain number of items or a certain amount of value of goods are required to fill out their personal information onto each slip of lucky draw coupons and place these in a box. In a preferred embodiment of the present invention, an end user (15, 16) can be issued with a lucky dip number. For example: F1234567 after purchasing either certain items at a store or shop or from a merchant, or a certain value of items. Instructions are provided on the lucky dip docket to submit the lucky dip number via SMS on a mobile device, to a specified number (for example: 655655).

Using the method of the present invention, the end user (15, 16) can also insert their name and identification number as follows:

DRAW <Lucky Draw no.><Name><Identification Card or NRIC No.>(where DRAW is the campaign CODE)

Example: DRAW F1234567 John Tan 6598741D

A SMS response confirms the entry.

All submitted SMS's in the lucky draw are analysed and sorted. Eligible entries are then entered and a winner selected, by known means. For example, the prize may be an e-coupon, which can be transmitted to the successful end user (15, 16) in manner described above. The operation of the system can be programmed to reject duplicates (where more than one lucky dip number submitted) and track people who persistently attempt to enter duplicate numbers. The system permits the merchant to conduct the on-line draw at any time, anywhere and to have the results automatically published on a website and to inform the winners by SMS. The identification of the card number of the end user (15, 16) can be used to confirm the authenticity of the redeemed e-coupon.

With the tracking that this method permits, statistical reports on the value of such prize draws or lucky dips can be made from the point of view of the merchant.

Furthermore, if each item purchased is tagged, the tagging (for example of each food item sold from a fast food store) with a specific code/number, and customer submission of the code for the lucky dip, will permit use of the system to build a sales-and-customer relationship analysis chart almost instantly. This analysis can be provided over the Internet to show the merchant how many kinds of items customer A has purchased from the store. Also available would be such information as: which are the faster selling or most popular food items in the store purchased by which age group of customer. This helps the merchant to refine the range of items (in the example, food items) to better serve the customers in that area.

### EXAMPLE 7

Message Management

In a further example of the system and method of the present invention, the invention permits the storage of Simple Messaging Service (SMS), Enhanced Messaging Service (EMS) and Multimedia Messaging Service (MMS) messages, such as Operator Logos, Picture Messages, Caller Group Icons, Screen Savers, Animations, Ring Tones, and other message types, into an internet enabled message box. This can be used in a situation where GSM mobile phones of the types currently available, which have a limited amount of storage for messages, can be overloaded.

The system can be accessed by defining a message to be sent to the server (19) to preview a table of extracts from stored messages as a single message of 160 characters. This allows the user to know the content of each message before forwarding it to other users from a mobile phone. The system can also be used to preview and print stored messages over the internet on a designated site.

The commands that can be used for message management, similar to that of an email system, include, but not limited to:

| Functions | Command |
|---|---|
| Store | ST |
| View Page | VP |
| View Message | VM |
| Create Group | GC |
| Add to Group | GA |
| View Group | GV |
| Group Delete | GD |
| Send | SD |
| Forward | FW |
| Delete Range | DR |
| Delete Message | DM |
| Delete All | DA |

The #ST command permits users (15, 16) to store up to a maximum of, but not limited to, one hundred messages.

Format: #ST#PASSWORD#<MESSAGE>#

Example: #ST#1234#This is a message.#

The system prompts the user (15, 16) with the location in which the message is stored. The reply message indicates that the location of the stored message is “23“and that there are 23 empty slots.

To select and view stored messages the user (15, 16) can request a page by page listing of stored messages, each page containing extracts of 10 messages and their index number.

Format: #VP#01#12345#

Reply message P1 1/5

01 SMS1

02 SMS2

. . .

10 SMS10

After viewing data, an end user (15, 16) can view a specific message by keying in the message number:

Format: #VM#MESSAGE NUMBER#PASSWORD#

Example: #VM#01#12345#

Reply Message:

This is stored message number 1.

You have no stored messages.

The user is also able to predefine a group profile for storage of subsidiary messages (in other words tiering the storage of messages under group headings.

Format:#GC01#GROUPID$MOBILEPHONENUMBER#

Example: #GC#01#BETTA#96964859#96964858#

Additional personnel can be added to an existing group:

Format: #GA#PASSWORD#GROUP ID#MOBILE PHONE NUMBER#. . .

Example: #GA#01#BETTA#96964859#96964858#. . .

View Group - #GV

Step 1 key in #GV followed by “#”key

Step 2 key in password followed by “#”key

Step 3 key in Group ID followed by “#”key

#GV#PASSWORD#GROUP ID#

Example: #GV#12345#BETTA#

Personnel can be deleted:

Format: #GD#PASSWORD#GROUP ID#

Example: #GD#12345#BETTA#

A user (15, 16) can send a message to one or more people independent of the mobile phone by utilizing the group feature of this preferred embodiment.

Format: #SD#PASSWORD#MOBILE NUMBER OR GROUP ID#. . . #MESSAGE#

Examples:

Sending a message to more than one number:

#SD#12345#96964859#96964858#This is my message#

Sending a message to a group and one number:

#SD#12345#BETTA#96964858#This is another message#

A user (15, 16) can forward a stored message:

Format: #FW#MESSAGE NUMBER#MOBILE PHONE NUMBER OR GROUP ID#. . .

Examples:

Forward message 1 to both 96964859 and 96964858.

#FW#01#96964859#96964858#. . .

Forward messages 1 and 9 to both 96964859 and 96964858.

#FW#01#09#96964859#96964858#...

Forward messages 1 and 9 to both 96964859 and 96964858 and message 7 to 96964857.

#FW#01#09#BETTA#96964858#07#96964857#

A user (15, 16) can delete a range of stored messages:

Format: #DR#PASSWORD#NUMBER RANGE#

Example: Delete SMS from location 1 to 50

#DR#12345#01-50#

A user(15, 16) can delete multiple messages or single message:

Format: #DM#PASSWORD#MESSAGE NUMBER#. . .

Example: Delete stored message 1 and 3

#DM#12345#01#03#. . .

And all stored messages can be deleted:

Format: #DA#PASSWORD#

Example: Deletes all messages

#DA#12345#

Reply Message

Your messages are ALL deleted.

### EXAMPLE 8

SMS can serve as an interactive tool that allows participants to compete in an interactive game, such as an interactive TV game show, that allows real time participation from home viewers.

Television game show has all along been bringing entertainment to viewers. From watching the contestants play the game show in the studio to participate the game show from home via phone calls, television game shows have gradually become increasingly more interactive.

The present invention covers the increase in home viewers' interest and enjoyment by allowing home participants to interact with a game show without experiencing the fear of talking on air. Such an approach of using mobile phone to submit answers via SMS allows more individuals to participate rather than fixed line phones, which many share. Moreover, most of the current telephone (fixed line) models are lacking in a screen, which provides visual affirmation of what they have keyed in through Interactive Voice Response Systems. This is unlike SMS that allows users to reaffirm what they have submitted. The SMS system consolidates and presents the answers received in a format tailored for display on the TV game show. The collated responses received from SMS can be presented in any format such as graphs, tables, charts and/or detailed listing etc. Furthermore, the organizers of the SMS campaigns can SMS in to query the latest consolidated results/responses.

With SMS, home viewers can participate as a contestant on a game show while it is aired. Home participants can play along live and in real time with the studio contestants either as partners or competitor.

A preferred embodiment of the present invention is an interactive game show where contestants are required to estimate the prices of merchandise. More than one home participant can partner or compete with the participants in the studio to gauge the price of any product. A message is shown on the television screen to notify home participants to key in their answer in the format such as

GAME.<ANSWER(S)>

The number of variables that follow after the service identifier command(“GAME”) are unlimited. As the home participants are instructed to send their answers to a prearranged number, the contestants in the studio key in their answer(s). The prices quoted by home players are displayed on the television screen once their answers are sent via SMS. The invention makes a comparison to identify the participant whose guess of the price is closest to the actual price of the said product.

The invention is also applicable to a game show where the quickest person to submit the correct answer wins. For example, a quiz question is revealed after which all contestants will challenge to see who is the first to provide the correct answer. To ensure fairness in the game, the studio contestants key in answers in the same format as home contestants.

Game participation via SMS is similarly applicable over pre-recorded television game shows. While the show is being aired, a game question is displayed on the television screen, asking home players to guess, for example, how much money a studio contestant had won. Consequently, the home participants receive a SMS reply whether they have won any prize.

The invention can also be used at the end of a talent competition where home viewers submit their guess on who will win the competition. Once the results are out, the system will be able to display on the television screen, the first 10 home viewers who made correct guesses.

Other examples include the voting for best advertisement, show, song or artist on television, which can be carried out via SMS over a period of time. The system is able to collate the responses and then sieve out the winners from the database.

Apart from interactive game shows, such invention includes, but is not limited to, competitions such as talent competitions, karaoke or dance competition, beauty pageants and the voting for best advertisement, show, song or artist on television (etc).

### EXAMPLE 9

Traditionally, in an office, task assignments and messages are conveyed either via telephone or email. Such dissemination lacks the automatic consolidation of responses. In a second preferred embodiment of the present invention, the dissemination and consolidation of data by employers or employees is carried out with a single SMS in the following format, not limiting the number of variables:

<COMMAND>.<VARIABLE 1>.<VARIABLE 2>

(COMMAND denotes the selected function. VARIABLE 1 and 2 require users to provide information such as the recipients and the task details)

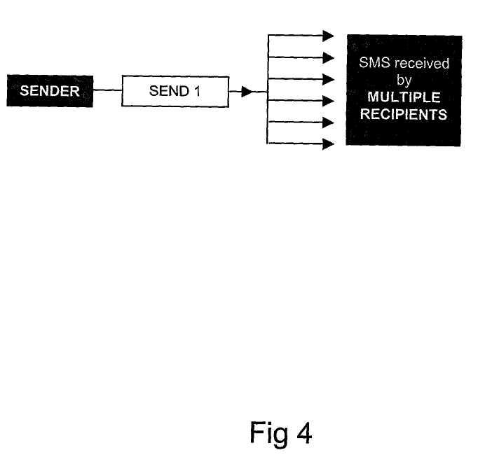

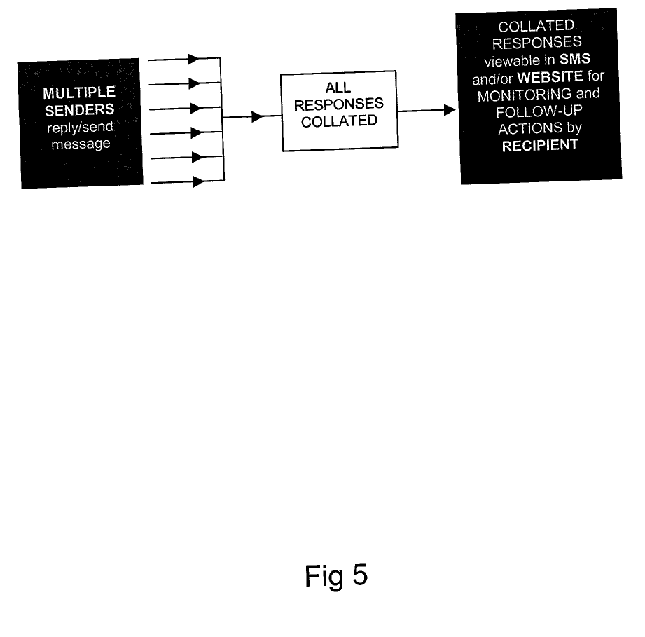

The dissemination and consolidation of messages follows the one-to-many and many-to-one concept respectively (see FIGS. 4 and 5).

Such inventions are applicable in various tasks, for example: assigning of work by a boss; the application of medical leaves; and meeting invitation.

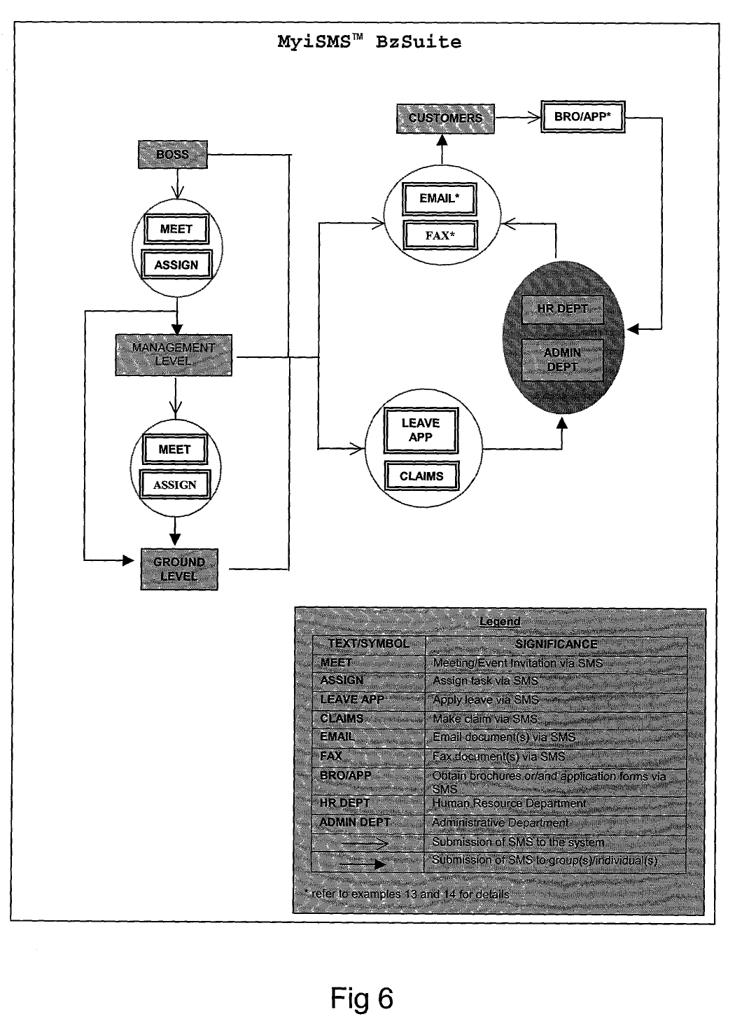

FIG. 6 shows an example of a flow of how the consolidation and dissemination of messages can be carried out via SMS in an office environment. Such flow is not limited to further expansion of relationships, functions, recipients and senders. It applies to all uses such as personal, public, office use.

### EXAMPLE 10

Use of SMS in Meeting/Event Invitation

In this embodiment, the invention provides a wireless invitation and consolidation of data, events, meetings through the use of SMS. Traditionally, sending the same message to x number of people requires the sender to compose and send x number of times. SMS provides the possibility of creating group profiles, allowing the same message to be sent to x number of people through a single composition and sent.

To send a meeting/event invitation (without specifying when to receive consolidated responses):

M.<GROUP ID(S)/INDIVIDUAL(S)>.<EVENT DETAILS

e.g.DATE/TIME/VENUE/AGENDA>(not limiting to different variable or configuration).

Example: M.SALES+DEPT.2/11/01 MEETING ABT COURSES 9AM IN RM L2

To send a meeting/event invitation (specifying when to receive consolidated responses via SMS):

M.<GROUP ID(S)/INDIVIDUAL(S)>.<EVENT DETAILS>.<TIME DURATION in minutes>

(not limiting to different variable or configuration).

Example: M.SALES+DEPT.2/11/01 MEETING ABT COURSES 9AM IN RM L2.30

Example of SMS received by Recipients:

2/11/01 MEETING ABT COURSES 9AM AT CONF RM L2. REPLY “Y” IF CAN ATTEND OR “N” PLUS COMMENT IF CANNOT.

To send a reply to the invitation with an additional comment:

<RECIPIENT's RESPONSE TO THE INVITATION>.<RECIPIENT's

COMMENT (optional)>(not limiting to different variable or configuration)

Example: N.I AM ON LEAVE DURING FIRST WEEK OF NOV

To allow a sender to retrieve the recipients' responses to a particular meeting/event:

MR.<KEYWORD(S) TO IDENTIFY WHICH EVENT e.g. MEETING DATE>(not limiting to different variable or configuration)

Example: MR.2/11/01 MEETING

Example of a consolidation of responses received via SMS (where Y and N indicates “Yes” and “No” respectively):

Meeting 2/11/01

Jack Y—No Problem!

Kim Y

Paul N—I am on leave during first week of Nov

Mtw Y—Free the entire day

Mik Y

This wireless group invitation and consolidation invention applies to any meeting, gathering or event for any office personnels, organizers, surveyors and interviewers. Refer to FIG. A for the configuration.

### EXAMPLE 11

Use of SMS in Medical Leave Application and Petty Cash Claim

Traditionally, an employee with a medical certificate has to telephone to inform the company that he is unable to report for work that day. The Human Resource (HR) department, in turn, has to jot down the information into the attendance book and refer to the book to follow up the next day.

The invention can create a morning reporting system whereby employees on MC can SMS to inform the company of their absence. The messages will automatically be sent to the system and are retrievable in a webpage specially formatted to keep track of the record of employees on MC. This implies that the HR department neither needs to receive calls from absentees nor jot down or key in any information about an employee on MC. Once an employee SMS to inform a company that he is unable to report for work, the SMS will automatically be reflected on the webpage. Therefore, the HR department only needs to log on to the website every morning to view the list of employees on MC for the day, their remaining number of Medical leaves and other collated information. Such approach enables the department to concentrate solely on the follow-up actions such as collecting MC from the staff and recording feedback (if any).

To apply medical leave:

MC.<DATE(S) OF ABSENCE in DDMMfonnat>.<REASONS>(not limiting to different variable or configuration)

Example: MC. 2109.FEVER

The morning reporting system receives this SMS and then automatically records the employee's name, date and reason of taking MC. Refer to Table 6.

This invention, apart from allowing the office staff to interact with the HR department regarding leave request, reporting record and attendance record, it also provides a channel of communication with the Administrative Department regarding, for example, the claiming of petty cash.

To make petty cash claim:

PC.<CLAIM DESCRIPTION e.g. CLAIM PURPOSE, DATE ON RECEIPT >.<CLAIMABLE AMOUNT>(not limiting to different variable or configuration)

Example: PC.TAXI CLAIM FOR 23/1 1/ 0 1.$15.30

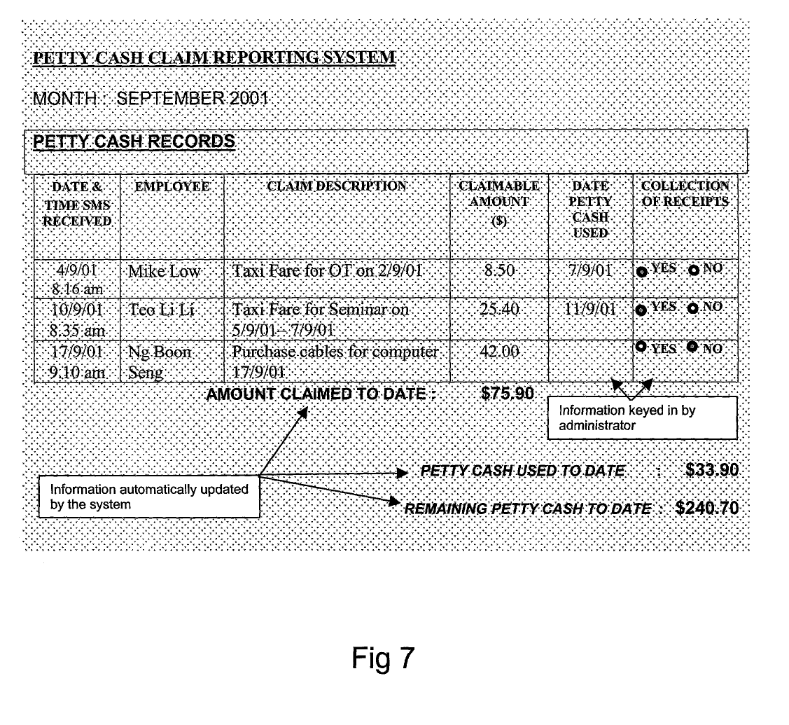

The system receives the SMS and then automatically records it into the website that consolidates all petty cash claims. Therefore, the department does not need to record any claim information and does not need to calculate the total amount of petty cash claimed or left per month. Refer to FIG. 7 for a typical web page layout.

This invention is applicable to leave request, claim request, reporting record and attendance record. Refer to FIG. B for configuration.

### EXAMPLE 12

Assigning tasks and monitoring subordinates' work can be difficult and sometimes almost impossible, especially when the boss is busy. Bosses who are not present in the office usually assign tasks to their subordinates either through phonecalls or email. Assigning via phonecalls is not efficient especially when the person the boss wishes to contact is not at his/her desk. Besides, unless the boss has recorded down, he may not be able to recall what task he has assigned and who he has assigned a particular work to. This makes it difficult for the boss to monitor his subordinates' work progress. Although assigning a task to a subordinate via email can serve as a record to trace the tasks assigned, such approach is still not viable all the time because the boss may not have access to a computer when he is outside the office.

The present invention which provides the ability to use SMS to assign tasks to subordinates is in an efficient and recordable manner. One of the reasons is that a person can easily and conveniently compose a SMS anywhere at anytime since he carries his mobile with him at most times. The second reason is that the invention enables a person to inform unlimited number of people of a similar task through a single SMS sent. Another reason is that every SMS sent to the subordinates is automatically recorded into a webpage specially designed with a platform to record every SMS sent by a person, hence allowing him to log on to view and monitor all the tasks he has assigned. Such Internet record enables him to continue monitoring by allowing him to insert updates on the progress of the work assigned.

To assign a task:

WK<ASSIGNED INDIVIDUAL(S)IGROUP(S)><ASSIGNED WORK>(not limiting to different variable or configuration)

Example: WK .PROGRAMMERS.COMPLETE PROJECT B BY 3PM FOR TESTING

The SMS sent is received by the recipients. Concurrently, the SMS is sent to the webpage, allowing the user to log on later to refer to the tasks he has already assigned. He can also insert remarks or updates of work progress into the webpage. Table 7 is an example of a tabulated Work Assignment in the webpage.

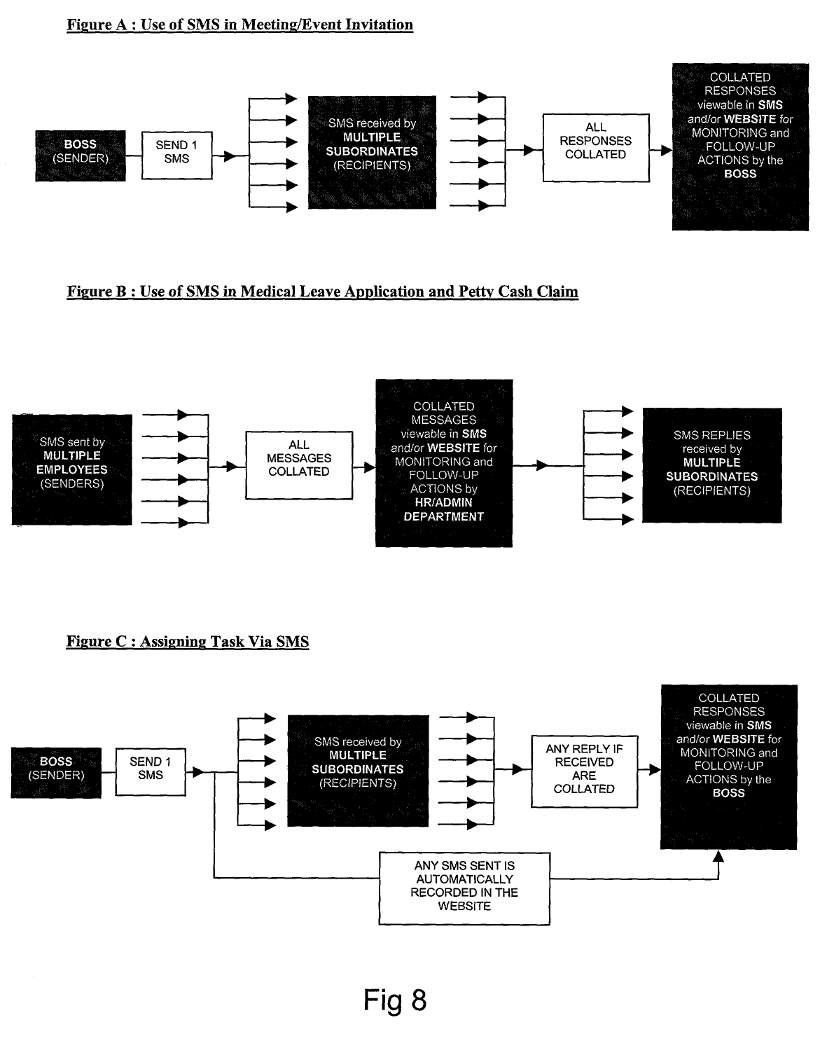

Such invention is applicable to any form of work assignment and monitoring process. Refer to FIG. 8 for the configuration.

In summary, these examples of the invention allow utilisation of SMS as a tool for information dissemination, consolidation, processing and reporting. It enables replies from recipients to be consolidated and displayed either on mobile phones, internet web pages, electronic mail and/or facsimile. The time duration taken to report the consolidated SMS recipients' responses can either be specified by the sender or automatically determined by the system.

The invention also allows correlation and/or calculations to be carried out on the consolidated recipients' responses. For example, the system can calculate the number of people who have not submitted their SMS reply or the number of positive or negative responses.

The sender can at any one time retrieve the recipients' responses to a particular event by sending a formatted SMS to activate the function. Alternatively, the invention also provides additional enhanced functionalities such as management and processing made available through Internet web pages.

The invention is applicable, but not limited, to the invitations to any event and/or place, management of human resources and/or delegation/assignment and management of duties/work/tasks.

### EXAMPLE 13

Traditionally, the sender must gather required documents before he faxes them to the recipient. Such approach restricts a person from sending a fax if he is not in the office. The invention of using the handphone to fax enables a person to fax a document without the need to be physically in front of a computer or fax machine. Through SMS, a person can either fax standard fax templates or selected documents/brochures. Once the sender includes in his SMS the details, such as the recipient's name, message and fax title, they will automatically appear on the fax cover page. Applying the same concept as mentioned above, SMS can also be used to email a document or brochure.

The following are the steps taken to carry out Template Faxing via handphone:

Step 1: Sender identifies the code of the fax template he wishes to send. The following are examples of fax templates prepared by a company:

| Code | Fax Template |
|---|---|
| T1 | Quotation |
| T2 | Delivery Request |
| T3 | Order Request |

Step 2: Sender composes a SMS in the following format:

F.<DOCUMENT CODE>.<RECIPIENT's NAME>.<FAX NUMBER>.<MESSAGE>

For example, a sender who wishes to fax a quotation to a customer can compose the following SMS:

F.T1.MIKE.256 8561.THIS QUOTATION IS VALID ONLY THIS YEAR

Step 3: Sender sends the SMS and the recipient will receive the fax. Refer to table 8.

The following are the steps taken to carry out the faxing of brochures or documents via handphone:

Step 1: Sender identifies the code of the brochure he wishes to fax to his customer. He may fax more than one set of brochures. The following are examples of brochures retrievable from the Brochure Retrieval Fax System:

| Code | Brochures |
|---|---|
| A | Free and easy tour to New Zealand |
| B | Cruise to nowhere (November-December period) |
| C | Guided tour to Australia 11D/10N |
| D | 5D/4N tour to Hongkong |
| E | Europe tour |

Step 2: Sender composes a SMS in the following format:

F.<DOCUMENT CODE>.<RECIPIENT's NAME>.<FAX NUMBER>.<MESSAGE>

For example, a sender, who wishes to fax to a customer the brochures about the tour to New Zealand, Hongkong and Europe, can compose the following SMS:

F.A,D,E.MIKE.256 8561.THESE BROCHURES ARE VALID ONLY IN 2001. FOR ANY QUERY, PLEASE CONTACT US.

Step 3: Sender sends the SMS and the recipient will receive the following fax cover letter and the requested sets of brochures. Refer to table 9.

Thus the invention discloses use of SMS to enable a person to fax a standard fax template or numerous sets of brochures without the need to be physically in front of a computer or fax machine. The sender is only required to SMS to activate the f unction. He can specify in his SMS what document to fax by keying in the code of the required document. There is no limit to the number of sets of documents that can be faxed through one SMS. Should the sender wishes to provide a short comment on the fax cover letter, he can do so by keying in the comment on the same SMS.

There is no limit to the number and type of fields allowable in a SMS. The SMS format can include fields like the document code, the recipient's name and fax number, the sender's message to the recipient.

Such invention is likewise applicable to the emailing of documents to recipients. In the SMS, the sender will key in the recipient's email address instead of the fax number. This wireless technology is not limited to any retail shop, service industry, advertising and printing firm.

### EXAMPLE 14

Traditionally, training institutions advertise a list of available courses on newspapers and magazines. An individual has to travel to the institutions to obtain brochures to find out details about the course he is interested in. Such approach results in unnecessary time and energy being wasted.

In the present invention, every course title advertised can be labeled with a code. Should any individual wish to find out greater details about the nature of a course, he can send a SMS and the requested brochures and application forms will automatically and instantly be emailed to him. For example, an institution may advertise about a diploma course in computer studies and invite the public to register. Interested individuals look out for the code found beside the course title and compose a SMS in the following format:

B.<course code>.<email address>

If the code for the course is 888, the formatted message to be sent should be, for example,

B.888.jack@yahoo.com

Upon submission of the SMS, the sender will receive the requested brochures and application form in his email.

Such invention is likewise applicable in travel agencies where a SMS can be sent to obtain travel brochures instantly in the email. Every travel package advertised on the newspaper can be labeled with a code. An individual interested in finding out more about the itinerary of a particular travel package can compose a SMS in the similar format above. The requested brochure and itinerary are then receivable via email. This invention is not limited to any service or retail industry.

### EXAMPLE 15

Traditionally, a person would either obtain and send a card or gift through the internet or purchase a card or gift from a store and send it through post. The first approach may be convenient but it does not allow the recipient to receive a hard copy of the card unless he prints it out. The second method is a sentimental approach but it is inconvenient as the sender has to search for a card or gift from one place to another before going to the post office to get it mailed.

The new invention has created a convenient yet sentimental approach of sending cards and gifts. Pictures of available cards and gifts are displayed on either on magazines, brochures, newspapers or on posters which are hung at selected places. Any interested passer-by can note the code of the card or gift he wishes to send, and then compose the first formatted message as follows:

<RECIPIENT's NAME>.<RECIPIENT's ADDRESS>.<CARD CODE>.<GIFT CODE>

If he wishes to specify when to deliver the card or gift, he can do so by adding to the above formatted message with a period followed by the delivery date. For example, a person requesting to deliver a card and gift to “Mike” on 24/10/01 can compose the SMS in the following manner:

MIKE.31 MAYFLOWER DRIVE SINGAPORE 750221.C888.G333.2410

Once the SMS above is sent, the sender receives a reply message confirming with the sender the name and address of the recipient and the card or gift to be mailed. The following is an example:

C888 G333 MIKE LOW 31 MAYFLOWER DRIVE SINGAPORE 750221 TO SEND, REPLY WITH GREETINGS FOR RECIPIENT

The sender does not need to continue to reply the above message should he decides not to send the card and gift to the person. If he wishes to continue to send, he can reply with a greeting (a maximum length of 160 characters) for the recipient. For example, he may wish to reply with the following SMS:

HAPPY BIRTHDAY MIKE! ENJOY YOUR DAY!

REGARDS, JOHN

The above message composed by the sender will then appear in the card that he has selected for Mike.

Once the system has received the SMS about the recipient's mailing details and the SMS about the content for the card, a confirmation SMS reply will be sent to the sender informing him that his request is in process.

SMS can be used to send greetings on a card, newspaper or magazine, and it can be used to send gifts such as checques, vouchers, air tickets, entrance tickets, flowers, toys. Hence, this invention is applicable for all floral shops, gift stores, retail shops, service industries, banks, advertising and printing firms.

Thus, the invention enables brochures, application forms or reading materials of any product or service, gifts, greeting cards and electronic greeting cards issued with a code to be sent to the sender via electronic mail, mail, facsimile or other means of delivery.

It allows personalization of requested merchandise by means of addition of greetings. It also allows the specification of delivery date(s) and method of delivery. It is applicable, but not limited, in areas like service or retail industry.

### EXAMPLE 16

Traditionally, showing a membership card or a discount coupon entitles a person to obtain discounts or incentives. Such approach serves only as an attraction to draw people to an outlet. However, the present invention of redeeming discounts through a wireless system not only serves as an appeal to the public but as an efficient marketing strategy. A wide array of data can be drawn with the use of the invention, namely the number of patrons and the number or type of products sold.

A further preferred embodiment of invention creates a wireless e-island at a tourist attraction or any recreational park which comprises of several outlets. Such approach employs a low cost wireless system whereby only one SMS needs to be composed and then sent to retrieve an e-coupon via SMS. Using this e-coupon in every outlet in a recreational park not only entitles the user to a discount, it allows the organization of the recreational park to collate or trace information such as the time and frequency of visits, the sales updates in each outlet and the location of a visitor at a particular time. Apart from providing visitors with a discount upon registration, the informative database allows the organization to provide further incentives such as lucky draws, rewarding high-spending visitors, giving every 100^{th} visitor a free ticket for his next visit and providing a further discount for those who have patronized a certain number of outlets within the park. Other than from the website, the organizers of the SMS campaigns can SMS in to query the latest consolidated results/responses. As marketing results are confidential, the system will strictly allow the consolidated data to be retrieved from the organizers' handphones only.

An illustration will be a tourist attraction where the visitors will either register via a registration form or SMS. The self-composed SMS can include any field that the organization wishes to survey such as the age and citizenship of the visitor. The following is an example of a formatted SMS:

<AGE>.<CITIZENSHIP>.<OCCUPATION>

Once the system receives the SMS, it beams to the sender a discount e-coupon which is applicable to any outlet within the tourist attraction. Should a person approach an outlet that requires him to pay an entrance fee, a discount is given to him once the e-coupon is shown to the cashier. The cashier validates the e-coupon by keying in the e-coupon's code into a mobile or system, whichever he is equipped with. With the submission of the code, the system also stores a range of data such as the time of visit, the frequency of visits, the number of tickets sold, the location of a particular visitor at a particular time. Other than viewing the consolidated data from the website, the organizers of the SMS campaigns can SMS in to query the latest consolidated results/responses. The data retrieved allows the organization to provide further incentives to visitors as a marketing strategy.

Thus, redeeming discounts, from an organization with numerous outlets through a wireless system, will serve both as an appeal to the public and as an efficient marketing strategy. The invention enables any organization to conduct a survey on the market, analyse public behaviour and retrieve recipients' particulars. The array of data retrievable from the system includes the number and types of patrons, the number or type of products or service sold, the time and frequency of visits to each outlet, the location of a visitor at any one time. Such data are updated continually and are viewable on any platform that enables the information to be displayed in a table, graph, chart and/or detailed listing. The organizers of the SMS campaigns can also SMS in to query the latest consolidated results/responses.

The collated responses from recipients can be used to provide further incentives such as lucky draws, rewarding high-spending patrons, giving every 100^{th} patron a free ticket for his next visit and providing a further discount for those who have patronized a specified number of outlets within the park.

The SMS to be composed and sent during registration can contain any field the organization is interested in collecting such as the age, name, occupation of the patron. Upon registration, the sender receives a reply message that can be served as any privilege ecard such as a discount, free gift.

### EXAMPLE 17

Traditionally, putting up an advertisement in the Classified section on print media or the internet requires a person to submit to the advertising firm a copy of the content to be printed. This is an inefficient approach as time is wasted on the delivery of the content to the advertising firm.

The invention enables the use of a wireless technology to provide fast display of new or updated information. A person can SMS to post an advertisement in the Classified section on either the webpage, newspaper or other print media. Such approach sends composed information swiftly upon request. Through just a single SMS, the webpage is automatically and instantly updated with the new advertisement.

To post an advertisement, a person only needs to send an SMS with the following format:

POST.<CATEGORY>.<ADVERTISEMENT CONTENT>

For example, the person interested in buying and selling of electrical products can send the SMS below:

POST.PRODUCTS.BUY & SELL Used/spoilt colour TV 14-61 $100 -$2000. VCR, VCD, DVD, mini compo, hi-fi, fridge. 7am-11pm. Hp 90261139 Mike

After the SMS is sent, the advertisement is then placed under the Products column in the Classified section on the newspaper or webpage.

Altering the advertisement on the website via the traditional approach can also be inefficient especially when one has to telephone or meet the web-designers to inform them of the amendments to be made. As a result, the traditional method of amending an advertisement in the webpage is also not quick enough to reflect latest updates instantly.

SMS provides instant alteration of the advertisement in the Classified webpage without the use of any manpower. A person can add, delete or modify the information in his current advertisement immediately just by sending a SMS in the respective format below:

ADD.<ADVERTISEMENT CODE>.<ADDED CONTENT>

DEL.<ADVERTISEMENT CODE>.<CONTENT TO BE DELETED>

MOD.<ADVERTISEMENT CODE>.<MODIFIED CONTENT>

Once the SMS is sent, the selected advertisement in the webpage is then automatically and instantly amended.

Traditionally, people search for product or service information by reading the Classified section on the newspapers. This can be inconvenient when they do not have newspapers in hand. The invention provides a 24-hour interactive information exchange service through a wireless technology. Through SMS, a person can, at any time, retrieve up-to-date information such as property search and sale, product price search and sale.

To obtain a search on a particular product or service, the following formatted message must be sent:

GET.<CATEGORY>.<PRODUCT/SERVICE DESCRIPTION e.g. PRODUCT MODEL, PRICE, LOCATION, AGE>

For example, person locating for an ideal HDB property in Ang Mo Kio can send the following SMS:

GET.HDB.ANG MO KIO BLK 104

A person searching for an ideal product such as a Palm IIIc can send the following SMS:

GET.PRODUCT.PDA 300 PALM IIIc

After the SMS is sent, he receives the search result in his reply message, such as:

PDA PALM3C $299 C96853274

The above reply message follows the format below:

<SERVICE / PRODUCT MODEL><PRICE><CONTACT NUMBER>

The exchanged information can be published in various media such as newspapers, the internet and television to get a wide exposure for interactivity via SMS. Any content and information created or updated can be a channel for use and dissemination in hard or soft copy particularly, but not limited to printing/publishing, entertainment, food, advertising, retail industries.

The invention can be used to post an advertisement in the Classified sections on print media, the Internet and/or other mediums of content delivery. The advertisement content submitted via SMS is either automatically inserted into the requested column in the Classified website or is received by the printing company for print on newspapers and magazines.

Apart from posting an advertisement, the invention also provides keyword search capabilities to search for advertised product or service via SMS. The advertisements retrieved from the search are then sent to the sender via SMS.

The invention also makes provisions for amendments, via SMS, of advertisement content of an internet webpage. Alterations can include the addition, deletion and modification of information.

The invention is applicable, but not limited, to any website such as Classified, advertising, auction, entertainment, retail, food website.

### EXAMPLE 18

Traditionally, two or more persons can chat either via phones or via online chat. This is not a flexible approach in situations where a phone is not accessible to one while a terminal is not accessible to another. A further preferred embodiment of the invention allows chat to be carried out via a mobilelus a website has enabled a person for example in a bus, to chat with a person in the office using a handphone and computer respectively. The chat content is automatically saved into the website for future retrieval. This embodiment is also applicable to personal use, for example, informal chat or office use such as discussion or formal meeting.

Thus, the invention allows a person to chat or discuss with another, via SMS, to another person who has log on to a chat website. The data received from the mobile phone and web page is saved into the website for retrieval at any time. The archived chat or discussion content can be presented in a format suitable for either personal reference or formal report. The invention is not limited to informal chat, discussion or formal meeting.

Other examples of uses of this system and method include the following: entry into a competition and draw for same and consolidation of results; information enquiry's on the internet; any company wishing to buy and sell services or goods through the internet to a mobile user by use of advertisements templates with an optional feedback system; conducting surveys with a specific template; etc. The list is not, however, meant to be defining or in any way limiting.

### Example 19

The m-Coupon management system encompasses the issuing of coupons by merchants, the registration of customers who are interested in the merchants' products/services, the automatic distribution of m-Coupons to the registered customers, and finally the m-coupon redemption by registered customers. Registration is carried out either wirelessly or via the Internet. In the wireless registration, a SMS composed in the following format will be sent to a pre-defined number.

<Name>.<Age>.<Email Address>

Upon signing up, the customer will receive a set of welcome m-coupons via SMS. In addition, a set of instructions on how to redeem the coupons will be emailed to him. Alternatively, the customer service officers can make phonecalls to the registered customers to obtain their mailing address so that instructional guides can be mailed to them. Any unregistered customer who tries to redeem m-Coupons will receive instructions via SMS or Internet on how to register to qualify for the redemption.

The redemption of m-coupons is carried out in a simple and instantaneous 2-step process. First, the customer can trigger the m-Coupon menu by sending a short SMS to a pre-defined number (the SMS can either be, for example, the initials/code of a shopping centre or the initials/code of a single merchant). If the customer SMS the initials/code of a shopping centre, he will receive in his mobile phone the m-Coupon menu displaying a list of coupons redeemable from the various merchants within the shopping centre. However, if the customer SMS the initials/code of a single merchant, he will receive an m-Coupon menu of coupons redeemable from that particular merchant. The following are examples of m-Coupon menu receivable via SMS.

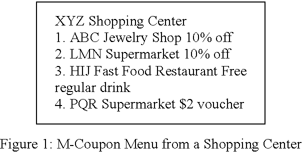

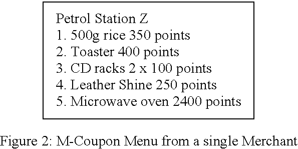

### FIG. 2: M-Coupon Menu from a Single Merchant

Second, the customer selects from the menu a particular coupon to redeem. To do so, he will simply compose the following SMS.

### <Coupon number><Merchant ID>

Therefore, to redeem the third m-Coupon from the list found in FIG. 1, he will send the following SMS

### 3 888

### (where 888 is an example of a merchant's ID)

An additional field can also be included in the above-mentioned format if merchants wish to track either the redemption amount or the transacted amount. Hence, any of the following formats can be adopted

### <Coupon number><Merchant ID><Product Amount (in cents)>

### <Coupon number><Merchant ID><Total Transacted Amount (in cents)>

### <Coupon number><Merchant ID><Redemption Amount (in cents)>

For example,

### 3 888 4250

### (where 888 is an example of a merchant's ID and 4250 refers to the product amount of $42.50)

Once the SMS is sent, the system will validate and then automatically update the list of m-Coupons that the customer has left. Subsequent m-Coupon menu queried by the same customer will not display the redeemed coupon.

Likewise, when a customer redeem any m-Coupon listed in the menu found in FIG. 2, the system will validate and then automatically update his m-Coupon list and at the same time, update the total number of points left in his account with the merchant. In other words, this innovation can operate like the current loyalty card programme where members can accumulate points and thereafter use their points in exchange for products/services. However, the difference between this and the traditional approach is that members need not carry cards anymore. All exchange and deduction of points will be carried out wirelessly.

Upon selection of the m-Coupon from the menu, the customer will receive a SMS message confirming that the selected m-Coupon has been redeemed.

Apart from redeeming m-Coupons wirelessly, the customer can also redeem m-Coupons by printing them out before presenting them to the cashier . There are three ways of printing m-Coupons. The first way requires the customer to log on to his email or m-Coupon website and thereafter select the m-Coupon to print out. The second way is to allocate a counter in the outlet with a keypad device connected to a GSM device and a printer. The customer will send SMS to retrieve the m-Coupon number, which he will then key into the keypad device. Once the system has validated the m-Coupon, the printer will print out the m-Coupon, which the customer will then use to present to the cashier for the redemption. The third way is to allow any customer to key in the coupon number and outlet number in his mobile phone. Thereafter, a m-Coupon will be printed out from a printer installed in the outlet for the customer to present to the cashier for the redemption (the printer is connected via a GSM device or an Ethernet connectivity to an Internet enabled network). Once a m-Coupon is printed, the system will automatically delete the m-Coupon from the customer's m-Coupon bin. Any update of records will also be carried out instantly.

The above described m-Coupon distribution and redemption can be an on-going event. Merchants can begin another promotional period at any time instantly. They will have to log on to the self-service DIY Promotion Internet website where they can add in new lists of m-Coupons and/or add in their advertisements. Once submitted, the system will immediately and automatically send the m-Coupon menu to any registered customers who have queried for promotions via SMS or Internet. Advertisement, if any, can either appear on its own in a SMS or it can tag behind the m-Coupon menu within the same SMS.

Records such as who the customers are and what and when they have redeemed can be derived in real-time from the system. Hence, monthly billing on the service used by merchants can easily be carried out by charging them a certain percentage on the total number of m-Coupons redeemed by customers.

While the method of m-Coupon redemption described above requires customers to first SMS to trigger the m-Coupon menu, the second method will require customers to forward a single m-Coupon received to a pre-defined number and then SMS the merchant's ID. This second method also makes validation of coupons possible through the matching of the sender's mobile phone number with the m-Coupon number (which will be the mobile phone number) found in the SMS message. The merchant ID sent in the second step will allow the system to record where the customer has redeemed the m-Coupon.

The two methods of m-Coupon redemption mentioned in this section are applicable to any organization and retail or service industry.

Aspects of the present invention have been described by way of examples and it should be appreciated that the concept and principals of the system described are most important but also that modifications and additions may be made thereto without departing from the scope thereof.

TABLE 1

| | | SEARCH | |
|---|---|---|---|
| S/NO | | CRITERIA | ABBREVIATION |
| 1 | Action | BUY | B |
| | KEY: | RENT | R |
| | Eg. | TRANSACTED | T |
| | BuyHDB => BH | BUS SEARCH | BS |
| | RentCondo => RC | | |
| | Transa- | | |
| | Detach => TD | | |
| 2 | Type | HDB | H |
| | | HUDC | U |
| | | CONDOMINIUM | C |
| | | PRIVATE APT | P |
| | | SEMI-DETACH | S |
| | | DETACH | D |
| | | TERRACE | T |
| | | BUNGALOW | B |
| | NUMBER OF | HDB TYPE | 2R |
| | ROOM | | 3R, 3I, 3NG, 3ST, 3A, |
| | | | 3S |
| | | | 4R, 4A, 4I, 4S, 4ST, |
| | | | 4NG |
| | | | 5R, 5I, 5S, 5A |
| | | | 6R |
| | | | EM, EA, EC |
| | | OTHERS | 2, 2 + 1, 3, 3 + 1, 4, |
| | | | 4 + 1, 5, 5 + 1, 6, |
| | | | 6 + 1, 7, 7 + 1, 8, |
| | | | 8 + 1, etc. |
| | | ADDRESS/ | SEE ATTACHED |
| | | ESTATE | |
| | | BUDGET (MAX) | 10,000 = 10 |
| | | IN THOUSANDS | 100,000 = 100 |
| | | (K) | 1,000,000 = 1000 |
| | | KEY: | 120,000 = 120 |
| | | Eg.(Unit in | 1,500,000 = 1500 |
| | | thousand(k)) | |
| | | $100 k =>k 100 | |
| | | $1 million =>k 1000 | |
| | | Address | Road Name |
| | | | Area/suburb |
| | | | District |

Query-HDB
Action: Rm: Type: Add: Blk: Budget (Optional)
Query-Condominium/HUDC/PRIVATE APT
Action: Rm: Type: Add: Blk: Budget (Optional)
Query-SEMI-DETACH/DETACH/TERRACE/BUNGALOW
Action: Rm: Type: Add: Blk: Budget (Optional)
Query-BUS SEARCH
Action: From Address: Destination address

[image]

1. A method of processing coded information in respect of a transaction by a user and a provider, the user being a user of a mobile phone with a search template, which phone is connectable to an SMS server, which in turn is connectable to the Internet; the provider having a GSM device connectable to a GSM terminal and to the Internet; each user having a unique identification number (“UIN”) for use in transactions; each provider having a unique identification number for use in transactions; wherein the method comprises the steps of
the user uses the search template to send the provider UIN and the user security number to the SMS server;
the SMS server confirms the validity of the provider UIN to the user by sending a secure acknowledgement in the form of an SMS signal readable on a mobile phone using the search template, and displayable to the provider;
the provider forwards the secure acknowledgement SMS to the SMS server;
the SMS server effects the completion of the transaction by directing an entry to specified records indicating the consideration offered the user for the transaction;
the SMS server sends a secure acknowledgement to the provider and the user, said acknowledgement being an SMS signal capable of being read through a search template on the mobile phone and by the GSM device, wherein
said template is in the form of a search index capable of carrying pre-determined information and coding instruction and being both capable of use for composing an alphanumeric message for broadcast, and capable of use for interpreting a received message, by the user, said message being transmitted through a mobile phone network and the SMS server.

2. A method of processing coded information in respect of a transaction by a user and a provider as claimed in claim 1 wherein the GSM device is selected from: a mobile phone, a POS (Point Of Sales) system device, a cellular phone with chatboard, and a cellular phone with keyboard.

3. A method of processing coded information in respect of a transaction by a user and a provider as claimed in claim 2 wherein the SMS signals are also in a human readable format, which is selected from: a facsimile transmission message and an email message.

4. A method of processing coded information in respect of a transaction by a user and a provider as claimed in claim 2 wherein said GSM device is connectable to an unstructured supplementary services data (USSD) system; which system is used in the transmission of the SMS messages.

5. A method of processing coded information in respect of a transaction by a user and a provider as claimed in claim 2 wherein said GSM device is connectable to a printer for a printed copy of any instructions, and any transaction.

6. A method of processing coded information in respect of a transaction by a user and a provider as claimed in claim 1 wherein the provider is selected from the group consisting of: a provider of goods, a retailer, a provider of services, a bank, and a combination thereof; the user is a customer; and the transaction is selected from: the purchase of goods, the purchase of services, use of customer loyalty coupons, issue of customer loyalty coupons; and a combination thereof.

7. A method of processing coded information in respect of a transaction by a customer and a merchant as claimed in claim 4 wherein the SMS server is connectable to at least a clearing house which is selected from: a security clearing house, a financial institution bank; a credit transfer facility; wherein the specified records in respect of which an entry is to be made to effect the completion of the transfer are contained at least one of said clearing houses.

8. A method of processing coded information in respect of a transaction by a customer and a merchant as claimed in claim 7 wherein the records altered to complete the transaction are selected from:
e-coupon records of the customer and e-coupon records of the merchant;
a credit card of the customer, and account of the merchant;
a bank account of the customer and of the merchant;
redemption of tickets from a competition;
entries in the records of a bonus point loyalty scheme; and a combination of these.

9. A method of processing coded information in respect of a transaction by a customer and a merchant as claimed in claim 8 wherein said GSM device is further connectable to a data storage medium, display device and programmable means of the merchant, said data storage device and programmable means being programmed to receive information on each transaction of the merchant, and whereby the programmable means is operable to display selections of information on the display device; which are selected from:
number, type and value of total sales in a given period of time;
number, type and value of specified types of sales in a given period of time;
number, type and value of bonus points generated and redeemed in a given period of time;
number, type and value of coupons dispensed and redeemed in a given period of time and a combination of these

10. A method of processing coded information in respect of a transaction by a customer and a merchant as claimed in claim 7 wherein said template is programmable to display summary information from a clearing house, said information being in respect of the user's account with the clearing house, and the information relating to the transactions of the customer for a specified period of time.

11. A method of processing coded information in respect of a transaction by a customer and a merchant as claimed in claim 2 wherein said transaction is a part of a customer loyalty scheme which scheme includes the issue and redemption of coupons for activities selected from: lucky dips; bonus; chance selection for rewards; purchase incentives; the issue of and a combination thereof.

12. A method of processing coded information in respect of a transaction by a user and a provider as claimed in claim 1 wherein said provider is club selected from a social club, a sports club, a hobby club; and said user is a member of said club; and wherein said transaction includes a club activity.

13. A method of processing coded information in respect of a transaction by a user and a provider as claimed in claim 1 wherein said provider is an advertiser of accommodation; said user is a seeker of accommodation; and said transaction includes information relating to said accommodation.

14. A method of processing coded information in respect of a transaction by a user and a provider as claimed in claim 1 wherein said provider is a game organiser; said user is a remote participant in a game and each transaction is a move in accordance with the rules of the game.

15. A method of processing coded information in respect of a transaction by a user and a provider as claimed in claim 14 wherein said game is a game broadcast live.

16. A method of processing coded information in respect of a transaction by a user and a provider as claimed in claim 1 wherein said provider is a receiver and sender of email messages; said user is a sender and receiver of email messages and the transaction is an email message.

17. A method of processing coded information in respect of a transaction by a user and a provider as claimed in claim 16 wherein said email messages are broadcast messages from the provider to at least one user.

18. A method of processing coded information in respect of a transaction by a user and a provider as claimed in claim 16 wherein said email messages incorporate at least one of the following: a facsimile message; a greeting card; a post card capable of electronic sending; and a combination thereof.

19. A method of processing coded information in respect of a transaction by a user and a provider as claimed in claim 16 wherein said provider is an employer and the user is an employee of the employer.

20. A method of processing coded information in respect of a transaction by a user and a provider as claimed in claim 19 wherein said transactions contains information on a topic selected from: employer information for employees, employee location; employee current tasks; employee future tasks; medical information for the employer from the employee; management schedules; information update on employee tasks; and a combination thereof.
